(19) United States
(12) Patent Application Publication
(10) Pub. No.: US 2007/0181622 A1
(43) Pub. Date: Aug. 9, 2007

(54) Carrying rack

(76) Inventor: Mark Rocchio, Los Angeles, CA (US)

Correspondence Address: WELSH & FLAXMAN LLC, 2000 DUKE STREET, SUITE 100, ALEXANDRIA, VA, 22314, US

(21) Appl. No.: 11/348,375

(22) Filed: Feb. 7, 2006

(51) Int. Cl. B60R 9/048; B60R 9/00; B60R 9/058

(52) U.S. Cl. 224/324; 224/325; 224/329

(57) ABSTRACT

A carrying rack includes a flexible first support rod, a roof attachment webbing strap coupled to the first support rod, and at least one equipment webbing strap coupled to the first support rod. The carrying rack also includes a flexible second support rod, a roof attachment webbing strap coupled to the second support rod, and at least one equipment webbing strap coupled to the second support rod.

### BACKGROUND OF THE INVENTION

1. Field of the Invention

The invention relates to a carrying rack. More particularly, the invention relates to a carrying rack relying upon the concepts of bow and fulcrum to ensure proper positioning of the rack upon an automobile.

2. Description of the Prior Art

As Americans have become more and more mobile, the need to carry things as they travel in their automobiles has become more important. Many items will easily fit within an automobile, while other items are just too large or odd-shaped. One group of articles that is often difficult to carry is very long items that are difficult to transport in a large vehicle, no less a standard-sized or small automobile. Examples of these items are surfboards, snowboards, skis, wakeboards, etc.

While car top carriers have been developed for these articles, the carriers are often expensive, difficult to install and use, and commonly semi-permanently secured to the automobile. As such, a need exists for a car top carrier that is portable, inexpensive and easy to use. The present invention provides a carrying rack achieving these goals.

### SUMMARY OF THE INVENTION

It is, therefore, an object of the present invention to provide a carrying rack including a flexible first support rod, a roof attachment webbing strap coupled to the first support rod, and at least one equipment webbing strap coupled to the first support rod. The carrying rack also includes a flexible second support rod, a roof attachment webbing strap coupled to the second support rod, and at least one equipment webbing strap coupled to the second support rod.

Other objects, advantages and salient features of the invention will become apparent from the following detailed description, which taken in conjunction with the annexed drawings, discloses a preferred, but non-limiting, embodiment of the subject invention.

### BRIEF DESCRIPTION OF THE DRAWINGS

FIG. 1 is a perspective view of the present carrying rack upon the roof of an automobile.

FIG. 2 is perspective view of the first support rod.

FIG. 3 is a cross sectional view of the first support rod.

FIG. 4, 5 and 6 are views showing assembly and installation of the first support rod.

FIG. 7 is a perspective view of a support rod in accordance with an alternate embodiment.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as the basis for teaching one skilled in the art how to make and/or use the invention.

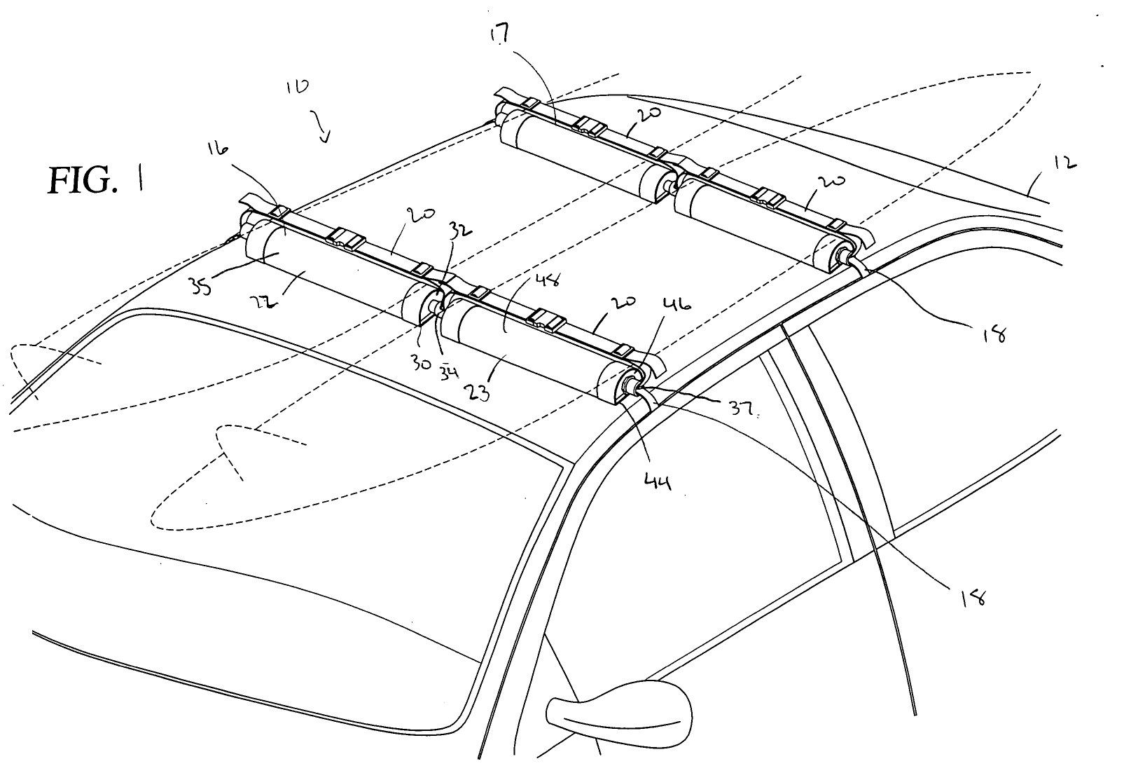

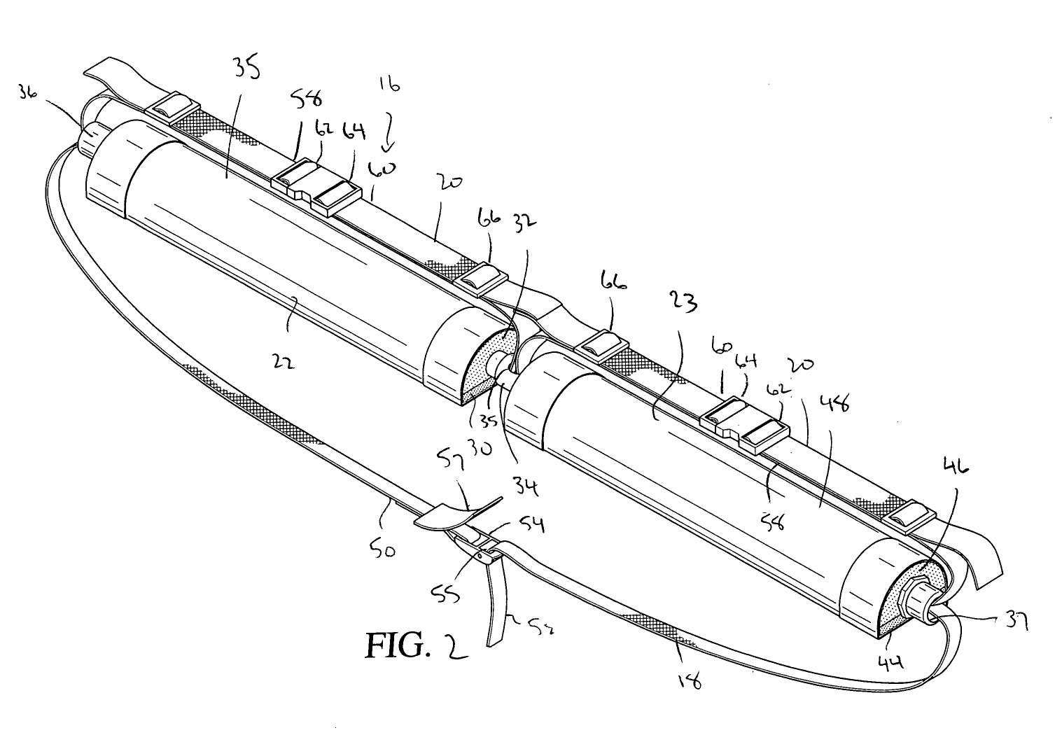

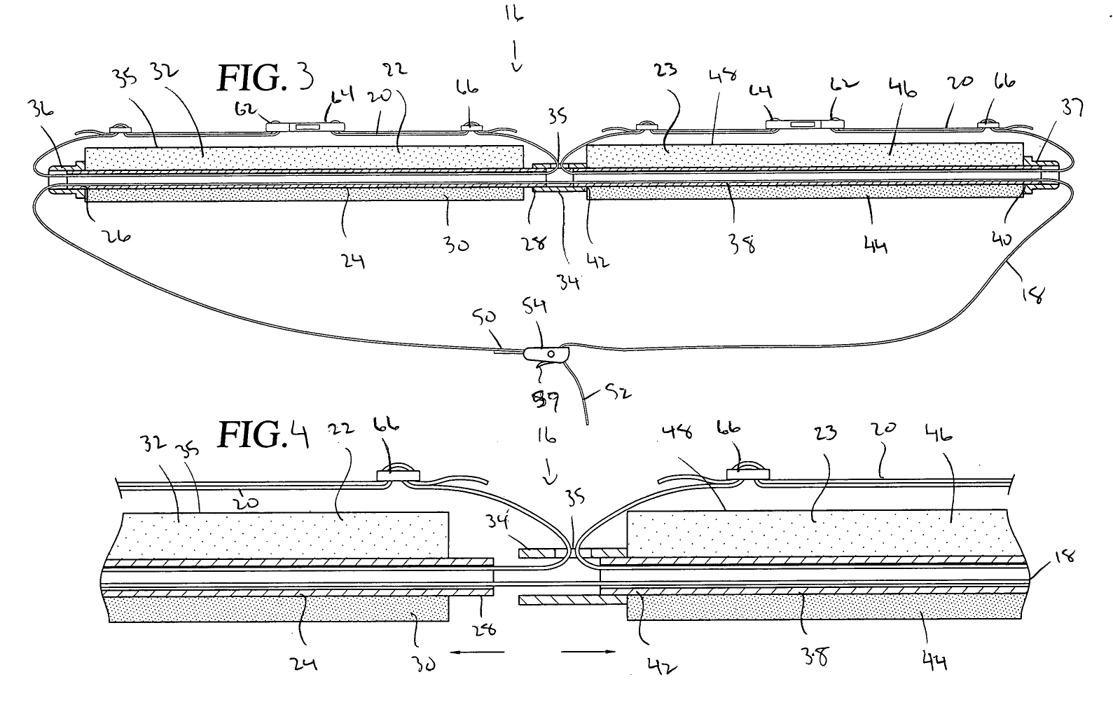

With reference to FIGS. 1 to 6, a soft, portable and removable automobile carrying rack 10 is disclosed. As will be discussed below in substantial detail, the present carrying rack 10 is designed to take advantage of the concepts of bow and fulcrum in achieving the goal of providing a convenient, reliable and inexpensive carrying rack 10 for use with a variety of automobiles 12. That is, and as will be appreciated based upon the following disclosure, the present carrying rack 10 takes advantage of its innate resilience to allow for secure attachment to the roof of an automobile 12. The present carrying rack 10 is specifically designed and constructed for use on the roof of an automobile 12 to carry single or multiple surfboards, snowboards, skis or other board sports equipment 14. Although the present carrying rack is designed for use in carrying sporting equipment, it may be used in carrying a variety of structures without departing from the spirit of the present invention.

Although the present carrying rack is disclosed for use with an automobile, the present carrying rack could be used with a variety of vehicles, for example, boats, without departing from the spirit of the present invention.

Generally, the present carrying rack 10 is composed of a series of flexible support rods 16, 17, roof attachment webbing straps 18 for attachment to the roof of an automobile 12, and equipment webbing straps 20 for attachment of equipment 14 thereto.

Referring to the support rods 16, 17, a dual system is disclosed herein. That is, each of the support rods (the front support rod and the rear support rod) includes two support members 22, 23 coupled in a manner discussed below in greater detail. However, those skilled in the art will appreciate the concepts underlying the present invention may be applied to single systems (that is, a support rod including a single support member) or multiple piece systems (that is, a support rod including two or more support members).

In accordance with a preferred embodiment, and with reference to FIG. 1, a front, or first, support rod 16 is provided for attachment along the forward end of the automobile roof and a rear, or second, support rod 17 is provided for attachment along the rearward end of the automobile roof. Although the terms front and rear are used herein in describing the present invention, the front and rear support rods are identical in accordance with a preferred embodiment of the present invention.

Since the front and rear support rods 16, 17 are identical in accordance with a preferred embodiment of the present invention, only the front support rod 16 will be described herein in detail. The front support rod 16 includes a first support member 22 and a second support member 23. As will be discussed below in greater detail, the first support member 22 and the second support member 23 are selectively coupled to create the front support rod 16, thereby providing a portable carrying rack 10 adapted for a variety of uses in accordance with the present invention.

The first support member 22 includes a central tube 24 including a first end 26 and a second end 28. In accordance with a preferred embodiment of the present invention, the central tube 24 is PVC tubing although other similar materials may be utilized without departing from the spirit of the present invention. The PVC is preferably ¾ inch Schedule 40 PVC, although those skilled in the art will appreciate that a variety of flexible tubing materials may be used without departing from the spirit of the present invention. Two different types of padding are secured about the central tube 24. A stiff, flat padding 30 is applied along one side of the central tube 24, while a softer, semi-circular padding 32 is applied around the central tube 24 so as to encase the central tube 24 between the flat padding 30 and the semi-circular padding 32. The flat padding 30 and semi-circular padding 32 are covered with waterproof material 35.

Similarly, the second support member 23 includes a central tube 38 including a first end 40 and a second end 42. In accordance with a preferred embodiment of the present invention, the central tube 38 is also PVC tubing although other similar materials may be utilized without departing from the spirit of the present invention. Two different types of padding are secured about the central tube 38. A stiff, flat padding 44 is applied along one side of the central tube 38, while a softer, semi-circular padding 46 is applied around the central tube 38 so as to encase the central tube 38 between the flat padding 44 and the semi-circular padding 46. The flat padding 44 and semi-circular padding 46 are covered with waterproof material 48.

Secure formation of the central tube 24, 38, flat padding 30, 44 and semi-circular padding 32, 46 is achieved by utilizing adhesive to securely hold the various components together. Secure positioning of the central tube 24, 38 is further enhanced by the provision of connectors 34, 36, 37 at the respective first and second ends 26, 28, 40, 42 of the central tubes 24, 38.

In accordance with a preferred embodiment, the flat padding 30, 44 and the semi-circular padding 32, 46 are composed of polyurethane, polystyrene or Styrofoam. As those skilled in the art will certainly appreciate, the specific padding used will be chosen based upon specific applications of the carrying rack, as well as the availability and cost of the padding.

As briefly mentioned above, the respective first and second ends 26, 28, 40, 42 of the central tubes 24, 38 of the first and second support members 22, 23 are provided with connectors 34, 36, 37. The various connectors 34, 36, 37 are hollow and allow for the passage of webbing straps 18, 20 therethrough in a manner discussed below in greater detail. With regard to the first ends 26, 40, the connectors 36, 37 are simply enlarged members secured at the respective ends. As to the second ends 28, 42 of the central tubes 24, 38, they are secured together through the application of a female connector 34 shaped and dimensioned to receive the second ends 28, 42 of the central tubes 24, 38 of the first and second support members 22, 23. The female connector 34 is provided with a laterally oriented aperture 35 for the passage of the equipment webbing straps 20 in a manner discussed below in greater detail. In accordance with a preferred embodiment, and in order to keep the female connector 34 intact with the carrying rack 10, the female connector 34 is adhesively bound to one of the central tubes 24, 38.

The central tube 24, 38 is designed to remain straight until proper pressure is applied by tightening the roof attachment webbing strap 18 around the vehicle's open doors. Through the principles of bow and fulcrum, the PVC central tube 24, 38 flexes laterally across the roof of the automobile 12, creating solid and unmovable contact on the vehicle. Secondary equipment webbing straps 20 are used to strap board sports equipment to the carrying rack 10.

As briefly mentioned above, a high strength polypropylene roof attachment webbing strap 18 is used to secure the front support rod 22 to the roof of an automobile 12. The roof attachment webbing strap 18 includes a first end 50 and a second end 52, and is passed through the front support rod 16 (both the first and second support members 22, 23 thereof) with the first and second ends 50, 52 thereof extending from the respective ends of the front support rod 16.

In accordance with a preferred embodiment, the roof attachment webbing strap 18 is wrapped around the vehicle's open doors with the respective ends 50, 52 of the webbing strap 18 coupled within the automobile 12. The first end 50 of the roof attachment webbing strap 18 is provided with a buckle member 54 through which the second end 52 of the webbing strap 18 is passed and selectively locked in a traditional manner. The first end 50 of the roof attachment webbing strap 18 is provided with a protective flap 57 designed to protect the car interior from contact with the buckle 54.

In accordance with a preferred embodiment of the present invention, the buckle 54 is a zinc cam-spring buckle and, therefore, the spring biased buckle 54 is secured to the first end 50 of the roof attachment webbing strap 18 and the second end 52 of the roof attachment webbing strap 18 is passed through an aperture 55 in the buckle 54 for selectively locking. As such, the second end 52 of the roof attachment webbing strap 18 is passed through the aperture 55 and pull tightly at which point it is locked relative to the buckle 54 via a spring loaded latch 59 of the buckle 54.

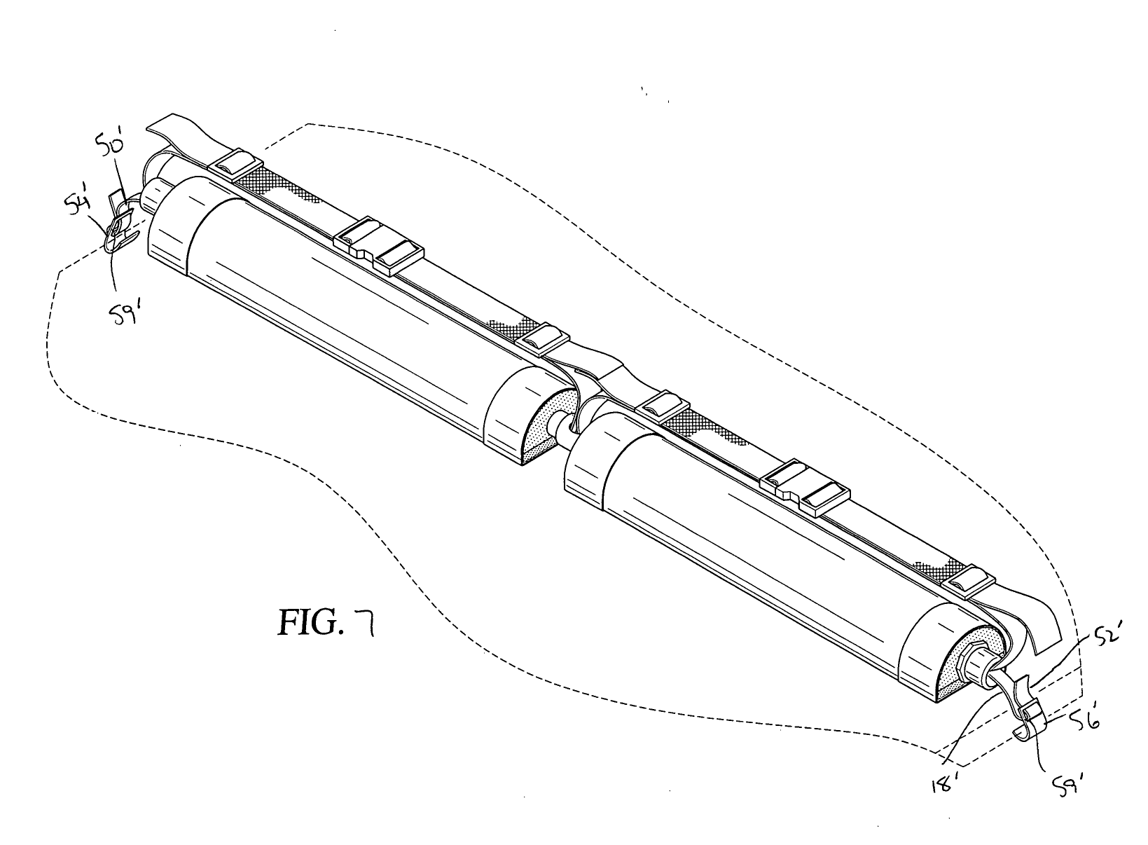

In accordance with an alternate embodiment of the present invention, and with reference to FIG. 7, the roof attachment webbing strap 18′ may be provided with metal hooks 54′, 56′ at its respective ends 50′, 52′ that attach to the inside door jamb of an automobile 12′. In the event such an embodiment is employed, length adjusting coupling members 59′ well known to those skilled in the art are formed along the hooks 54′, 56′ to allow for tightening of the roof attachment webbing strap 18′ in a manner securing the front support rod 16′ to the roof of an automobile 12′.

Although contemplated coupling structures for the roof attachment webbing strap are disclosed in accordance with preferred embodiments of the present invention, other coupling structures may be employed without departing from the spirit of the present invention. For example, D-ring connectors, Velcro or Velcro-type materials, hook devices or securing and tying systems could be used in accordance with the present invention.

In addition to the roof attachment webbing straps 18, the first and second support members 22, 23 are respectively provided with first and second equipment webbing straps 20 (as those are identical, similar reference numerals will be used). Each of the first and second equipment webbing straps 20 passes through the respective central tubes 24, 38 of the first and second support members 22, 23, exiting at either end 26, 40 of the central tubes 24, 38 or the aperture 35 formed in the female connector 34. The first and second ends 58, 60 of the first and second equipment webbing straps 20 are respectively provided with mating plastic snap fastening members 62, 64 well known to those skilled in the art. As it may be necessary to adjust the length of the respective first and second equipment webbing straps 20, each of the straps 20 is provided with length adjusting coupling members 66 well know to those skilled in the art positioned along the length of the equipment webbing straps 20 to allow for tightening of the equipment webbing straps 20 in a manner securing equipment to the present carrying rack.

Although polypropylene webbing straps are disclosed in accordance with a preferred embodiment of the present invention, it is contemplated the webbing straps might also be cotton or nylon or other strapping materials without departing from the spirit of the present invention.

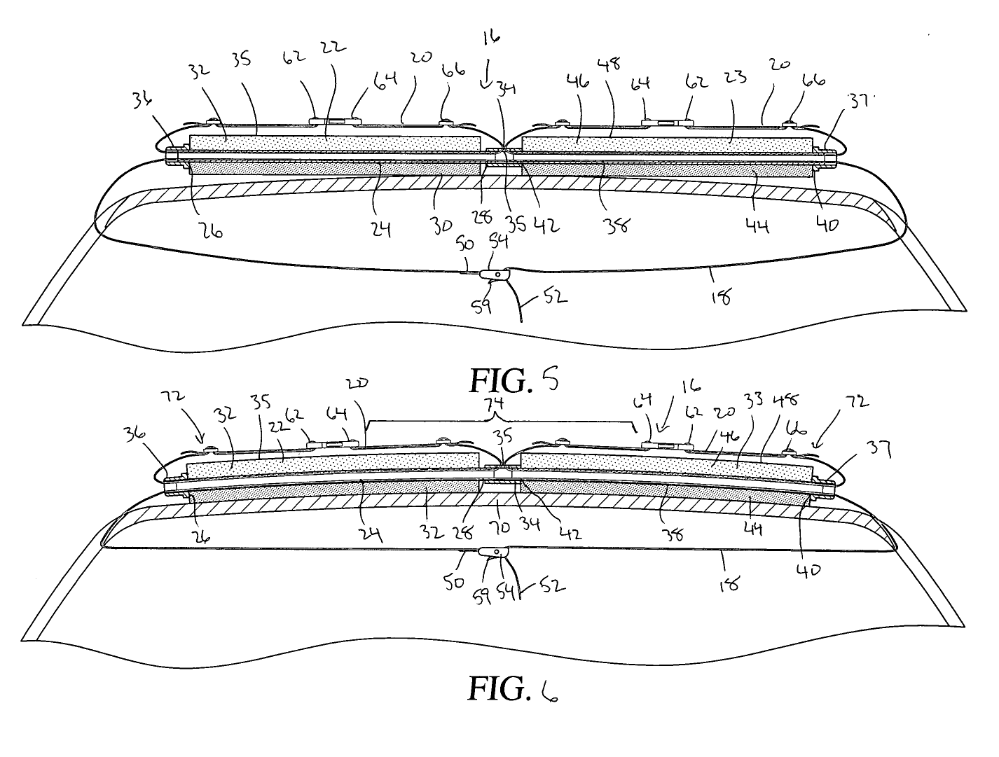

As mentioned above, the rear support rod is structured just as the first support rod described herein in detail, and similar reference numerals are used to designate similar components thereof Referring to FIGS. 4, 5 and 6, when it is desired to place the present carrying rack 10 on the roof of an automobile 12, the first and second support members 22, 23 are coupled together using the female connector 34 shaped and dimensioned for positioning therebetween. Once this is completed, the front support rod 16 is positioned on the roof of the automobile 12 extending laterally thereacross with the flat padding 30,44 facing the surface of the automobile roof. The roof attachment webbing strap 18 is then passed through the open doors of the automobile 12 and the second end 52 of the roof attachment webbing strap 18 is passed through the buckle 54. At this point, no tension has been applied to the front support rod 16 and it sits substantially straight upon the crown of the automobile's roof.

The length of the roof attachment webbing strap 18 is then adjusted by pulling the second end 52 thereof through the buckle 54 until the tension upon the front support rod 16 is sufficient to bow the central tubes 24, 38 thereof (see FIG. 6). Thereafter, the buckle 54 is locked upon the second end 52 securing the roof attachment webbing strap 18 in a desired tensioned orientation. When the central tubes 24,38 are bowed across the roof of the automobile 12, the principle of fulcrum will push down on the carrying rack 10 with sufficient force as to prevent the carrying rack 10 from moving in any direction, therefore, securing safely any load placed on it including but not limited to surfboards, snowboards, skis, wakeboards or any material that will fit within the present carrying rack 10.

By tightening the roof attachment webbing strap 18 and bowing the front support rod 16 about the crown 70 of the automobile's roof, the ends 72 of the front support rod 16 are pulled downwardly into contact with the automobile's roof while the central portion 74 of the front support rod 16 is biased toward the crown 70 under the biasing pressure generated by the resilience of the front support rod 16. The downward pressure at the central portion 74 of the front support rod 16 is substantial and creates a strong frictional engagement that works in conjunction with the frictional resistance generated at the ends 72 of the first support rod 16 by the pulling of the tightened roof attachment webbing strap 18 to hold the front support rod 16 in position. More particular, tightening of the roof attachment webbing strap 18 creates internal forces within the first support rod 16 wherein the central portion 74 has a downward bias toward the roof of the automobile 12 which is substantially equal to the upward bias at the ends 72 of the front support rod 16 countering the downward pull of the roof attachment webbing strap 18.

Once the front support rod 16 is properly positioned, the rear support rod 17 is assembled and secured in a similar manner (the rear support rod could certainly be positioned before the front support rod). After the front and rear support rods 16,17 are properly secured to the automobile, equipment may be secured to the upper surface defined by the semi-circular padding 32, 46 by laying the equipment upon the front and rear support rods 16, 17 and coupling the equipment webbing straps 20 about the equipment with sufficient tension to secure the equipment thereto.

The present rack provides a removable, soft tack system for securing surfboards, snowboards, skis, wakeboards or any other sporting or non-sporting materials that will fit on the rack comprising.

While the preferred embodiments have been shown and described, it will be understood that there is no intent to limit the invention by such disclosure, but rather, is intended to cover all modifications and alternate constructions falling within the spirit and scope of the invention.

1. A carrying rack, comprising:
a flexible first support rod, a roof attachment webbing strap coupled to the first support rod, and at least one equipment webbing strap coupled to the first support rod; and
a flexible second support rod, a roof attachment webbing strap coupled to the second support rod, and at least one equipment webbing strap coupled to the second support rod.

2. The carrying rack according to claim 1, wherein the first support rod includes a first support member composed of a central tube encased in padding; and the second support rod includes a first support member composed of a central tube encased in padding.

3. The carrying rack according to claim 2, wherein the equipment webbing strap of the first support rod passes through the central tube of the first support member of the first support rod; and the equipment webbing strap of the second support rod passes through the central tube of the first support member of the second support rod.

4. The carrying rack according to claim 2, wherein the central tube of the first support rod is composed of PVC and the central tube of the second support rod is composed of PVC.

5. The carrying rack according to claim 2, wherein the padding of the first support member of the first support rod includes a flat padding and a semi-circular padding, and the padding of the first support member of the second support rod includes a flat padding and a semi-circular padding.

6. The carrying rack according to claim 2, wherein the first support rod includes the first support member and a second support member composed of a central tube encased in padding; and the second support rod includes the first support member and a second support member composed of a central tube encased in padding.

7. The carrying rack according to claim 6, wherein a first equipment webbing strap passes through the central tube of the first support member of the first support rod, a second equipment webbing strap passes through the central tube of the second support member of the first support rod, a third equipment webbing strap passes through the central tube of the first support member of the second support rod and a fourth equipment webbing strap passes through the central tube of the second support member of the second support rod.

8. The carrying rack according to claim 7, wherein the roof attachment webbing strap of the first support rod includes a first end and a second end, and a buckle is secured at the first end of the roof attachment webbing strap of the first support rod; and the roof attachment webbing strap of the second support rod includes a first end and a second end, and a buckle is secured at the first end of the roof attachment webbing strap of the second support rod.

9. The carrying rack according to claim 8, wherein the first support member and the second support member of the first support rod are selectively connected; and the first support member and the second support member of the second support rod are selectively connected.

10. The carrying rack according to claim 6, wherein the roof attachment webbing straps respectively pass through the first support rod and the second support rod.

11. The carrying rack according to claim 10, wherein the first support member and the second support member of the first support rod are selectively connected; and the first support member and the second support member of the second support rod are selectively connected.

12. The carrying rack according to claim 1, wherein the roof attachment webbing straps respectively pass through the first support rod and the second support rod.

13. The carrying rack according to claim 12, wherein the roof attachment webbing straps are composed of a high strength polypropylene.

14. The carrying rack according to claim 12, wherein the roof attachment webbing strap of the first support rod includes a first end and a second end, and a buckle is secured at the first end of the roof attachment webbing strap of the first support rod; and the roof attachment webbing strap of the second support rod includes a first end and a second end, and a buckle is secured at the first end of the roof attachment webbing strap of the second support rod.

15. The carrying rack according to claim 12, wherein the roof attachment webbing strap of the first support rod includes a first end and a second end, and respective hooks shaped and dimensioned for attachment to the inside door jamb of an automobile are secured at the first end and the second end of the roof attachment webbing strap of the first support rod; and the roof attachment webbing strap of the second support rod includes a first end and a second end, and respective hooks shaped and dimensioned for attachment to the inside door jamb of an automobile are secured at the first end and the second end of the roof attachment webbing strap of the second support rod.

16. The carrying rack according to claim 1, wherein the first support rod includes a first support member composed of a central tube encased in padding and a second support member composed of a central tub encased in padding; and the second support rod includes a first support member composed of a central tube encased in padding and a second support member composed of a central tub encased in padding, and the equipment webbing straps respectively pass through the first support members and the second support members of the first and second support rods.

17. The carrying rack according to claim 16, wherein the equipment webbing straps are composed of a high strength polypropylene.

18. The carrying rack according to claim 16, wherein the equipment webbing strap of the first support rod includes a first end and a second end, and respective mating buckling members are secured at the first end and the second end of the equipment webbing strap of the first support rod; and the equipment webbing strap of the second support rod includes a first end and a second end, and respective mating buckling members are secured at the first end and the second end of the equipment webbing strap of the second support rod.
